(19) United States
(12) Patent Application Publication
(10) Pub. No.: US 2017/0286325 A1
(43) Pub. Date: Oct. 5, 2017

(54) METHOD AND SYSTEM FOR DEFINING LOGICAL BLOCK ADDRESSING (LBA) ACCESS PERMISSION IN STORAGE DEVICES

(71) Applicant: Samsung Electronics Co., Ltd., Suwon-si (KR)

(72) Inventors: Vikram SINGH, Bengaluru (IN); Vamshi Krishna KOMURAVELLI, Bengaluru (IN); Manoj THAPLIYAL, Bengaluru (IN)

(73) Assignee: Samsung Electronics Co .. Ltd., Suwon-si (KR)

(21) Appl. No.: 15/392,273

(22) Filed: Dec. 28, 2016

(30) Foreign Application Priority Data
Mar. 29, 2016 (IN) 201641010888

(51) Int. Cl. G06F 12/14; G06F 13/42

(52) U.S. Cl. CPC G06F 12/1466; G06F 13/4282; G06F 2212/1052

(57) ABSTRACT

Method, system, apparatus, and/or non-transitory computer readable medium for customizing data access permission in a data storage system. The system allows for the defining of data access permissions at a function level such that different functions in a host can have different data access permissions, for particular data stored in a storage device of the system.

### CROSS REFERENCE TO RELATED APPLICATION

This non-provisional U.S. application claims the benefit of priority under 35 U.S.C. §119(e) to Indian Patent Application No. 201641010888, filed on Mar. 29, 2016 in the Indian Patent Office, the entire contents of which are incorporated herein by reference.

### FIELD

Various example embodiments herein relate to digital data storage systems and, more particularly, access permissions defined at multiple function levels for Solid State Devices (SSDs).

### BACKGROUND

Peripheral Component Interconnect Express (PCIe) bus based storage systems are popular because they offer high scalability and processing speed, features which allow production of high capacity devices that support storage spaces of tens of Terra Bytes (TB).

Data stored in a storage device may have to be accessed by different hosts, i.e., the data needs to be shared between different hosts (e.g., different computing devices, peripheral devices, users, operating systems, virtualized devices, virtualized operating systems, etc.). Some of the existing devices enable computing devices and their hosted virtual machines to connect to, and simultaneously request services from the shared device functions. Such devices are referred to as ‘multi-function devices’ in PCI Express terminology.

Sharing of data among hosts gives rise to security concerns as well. While a storage device may be configured to allow sharing of data with multiple hosts, it is also important to define the data that each host can access, and the kind of activities each host can perform using the data being accessed. Trusted Computing Group (TCG) provides a mechanism that allows defining access permission as at least one of READ/WRITE, ONLY READ, ONLY WRITE, and NO ACCESS, for different hosts, or in other words, allows defining access permissions on a per-host basis. Further, the data access capability as well as the action(s) each host can perform on the accessed data are restricted according to the permission set for the host, thereby addressing data privacy and security concerns.

However, the TCG, as well as other mechanisms, require defining access permissions at the host level. A host may comprise multiple functions, and the data access requirements of each host may vary. As the permission is common for all PCIe functions that a specific host requires, certain PCIe functions may end up not receiving the necessary permissions to function properly, thereby impacting the usability of the PCIe-based host and/or the use of the TCG or other security settings, and certain other PCIe functions may end up having access to unnecessary data, thereby creating a security risk.

### SUMMARY

An object of at least one of the example embodiments herein is to define TCG range values for defining access permission.

Another object of at least one of the example embodiments herein is to permit multi-host usage of TCG ranges.

Another object of at least one of the example embodiments herein is to permit host level access to TCG ranges.

Another object of at least one of the example embodiments herein is to define different permissions for different functions of a PCIe device, as per TCG LBA ranges.

In view of the foregoing, at least one example embodiment herein provides a method for customizing access permission to a storage device for at least one Peripheral Component Interconnect Express (PCIe) function of a host. The method includes defining, using at least one processor, at least one Logical Block Addressing (LBA) range for data in the storage device, defining, using the at least one processor, at least one lock status associated with the at least one PCIe function associated with the defined LBA range, and determining, using the at least one processor, an access permission for the PCIe function of the host based on the defined lock status of the PCIe function.

Some Example embodiments further disclose a storage device for customizing access permission for at least one Peripheral Component Interconnect Express (PCIe) function of a host to data stored in the storage device. The storage device includes a hardware processor, a non-volatile memory comprising computer readable instructions, which when executed by the hardware processor, cause the hardware processor to, define at least one Logical Block Addressing (LBA) range for data in the storage device, define at least one lock status associated with the at least one PCIe function associated with the defined LBA range, and determine an access permission for the PCIe function of the host based on the defined lock status of the PCIe function

According to another example embodiment, a method for managing a Logical Block Addressing (LBA) range includes receiving, using at least one processor, at least one data access request from at least one Peripheral Component Interconnect Express (PCIe) function associated with a host, the data access request including a desired LBA range and a desired access type, verifying, using the at least one processor, the data access request based on a LBA range table record of a LBA range table associated with the desired LBA range, the PCIe function, and the host, and permitting, using the at least one processor, the data access request based on results of the verifying.

These and other aspects of the example embodiments herein will be better appreciated and understood when considered in conjunction with the following description and the accompanying drawings.

### BRIEF DESCRIPTION OF THE DRAWINGS

The foregoing and other features of inventive concepts will be apparent from the more particular description of non-limiting, example embodiments of inventive concepts, as illustrated in the accompanying drawings in which like reference characters refer to like parts throughout the different views. The drawings are not necessarily to scale, emphasis instead being placed upon illustrating principles of inventive concepts. In the drawings:

FIG. 1 illustrates a block diagram of data management system that permits selective data access permissions for different functions of a host according to at least one example embodiment;

FIG. 2 is a flowchart diagram that depicts a method of allowing data access permissions at a PCIe function level by the data management system according to at least one example embodiment; and

FIG. 3 is an example diagram illustrating a LBA range table that includes the lock status for at least one LBA range according to at least one example embodiment.

### DETAILED DESCRIPTION

The various example embodiments herein and the various features and advantageous details thereof are explained more fully with reference to the non-limiting example embodiments that are illustrated in the accompanying drawings and detailed in the following description. Descriptions of well-known components and processing techniques are omitted so as to not unnecessarily obscure the example embodiments herein. The examples used herein are intended merely to facilitate an understanding of ways in which the example embodiments herein may be practiced and to further enable those of skill in the art to practice the example embodiments herein. Accordingly, the examples should not be construed as limiting the scope of the example embodiments herein.

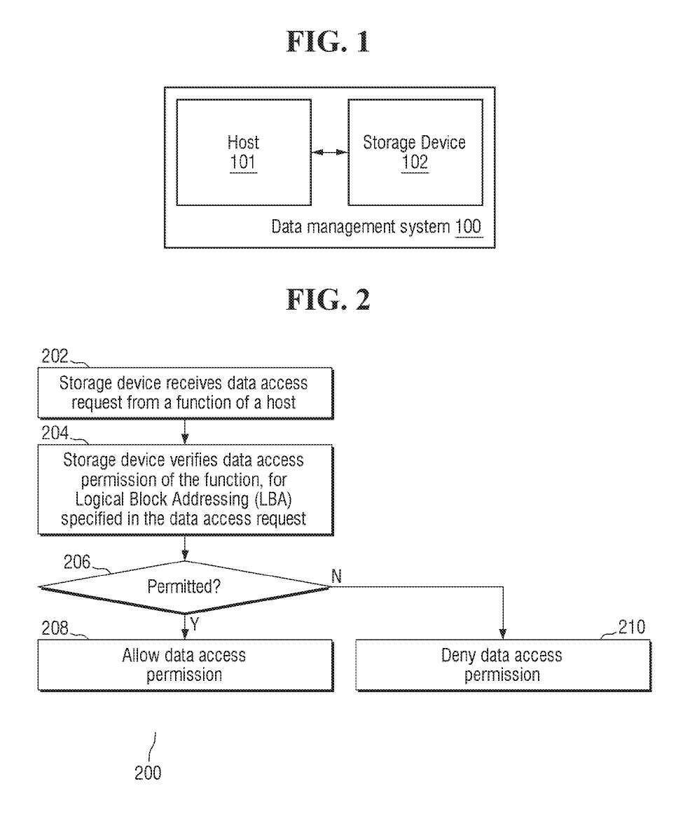

Various example embodiments herein disclose a mechanism for defining data access permission at a Peripheral Component Interconnect Express (PCIe) function level in a data management system. Referring now to the drawings, and more particularly to FIGS. 1 through 3, where similar reference characters denote corresponding features consistently throughout the figures, there are shown several example embodiments.

FIG. 1 illustrates a block diagram of a data management system at permits selective data access permissions for different functions of a host according to at least one example embodiment. The data management system comprises a host 101 and a storage device 102, but is not limited thereto. The number of hosts and storage devices may vary based on different implementation standards and per design requirements.

The host 101 may be any device (e.g., computer, peripheral device, hardware component, etc.) that may be configured to communicate with the at least one storage device 102. (e.g., hard drive, solid-state drive, flash drive, other memory device, etc.), using at least one suitable communication channel, such as a PCIe channel. The host 101 may be further configured to accommodate at least one PCIe function which requires access to at least one data stored in the storage device 102. The host 101 may be further configured to allow the PCIe function to request data access from the storage device 102, and then fetch the requested data upon receiving data access permission from the storage device 102.

The storage device 102 may be any data storage system that allows data to be stored in at least one desired (or, alternatively pre-defined) format. The storage device 102 may be further configured to use Logical Block Addressing (LBA) for storing data, and may define one or more LBA ranges corresponding to the data stored in a LBA range table. The storage device 102 may be further configured to provide at least one option to define data access permission of each of the LBA ranges at a PCIe function level. The storage device 102 may be further configured to receive a data request from at least one PCIe function of the at least one host 101, and verify data access permission of the function, to the corresponding LBA range. The storage device 102 may be further configured to define the lock status for each PCIe function of the host 101 corresponding to the LBA ranges defined and stored in the storage device 102. The storage device 102 may be further configured to allow or deny a data access request based on the desired and/or pre-defined data access permission set for the LBA range included in the data access request.

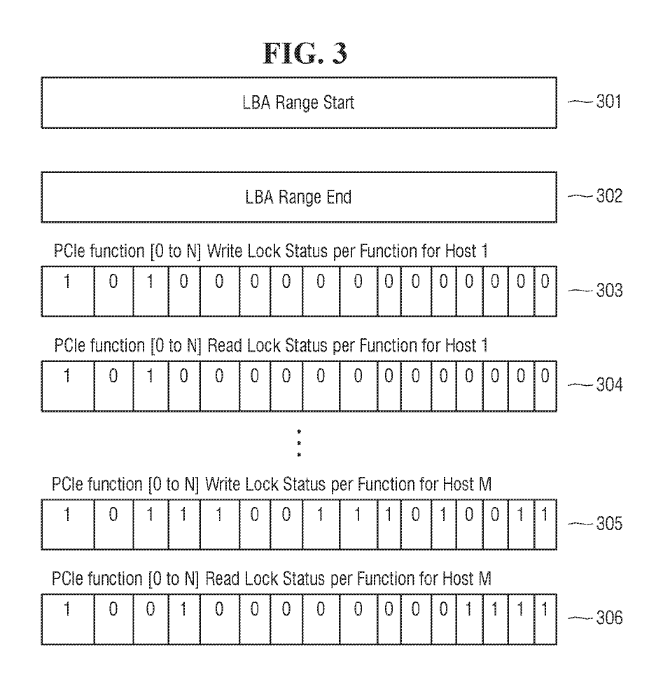

FIG. 2 is a flowchart diagram that depicts a method for allowing data access permissions at a function level by the data management system according to at least one example embodiment. At step 202, the storage device (e.g., storage device 102) receives a data access request from a PCIe function of one or more hosts (e.g., host 101). The data access request includes a LBA range corresponding to the data desired by the PCIe function of the host, as well as the access type requested by the PCIe function (e.g., read access, write access, read/write access, etc.). At step 204, the storage device 102 verifies the received data access request. During the verification process, the storage device 102 identifies, from the received data access request, a LBA range corresponding to the data being requested by the function. The storage device 102 further checks the lock status defined for the specified PCIe function for the identified LBA range in a LBA range table, wherein the lock status defines the data access permission for the specified PCIe function for the LBA range for each host defined in the LBA range table. The LBA range table may be stored in at least one Special Function Register (SFR) of the storage device. The LBA range table will be discussed in further detail in connection with FIG. 3. If the value of lock status for the PCIe function for the requested LBA range stored in the LBA range table indicates that the PCIe function is allowed to access data then the storage device 102 allows data access permission at step 208. If the value of lock status for the PCIe function for the requested LBA range stored in the LBA range table indicates that the PCIe function is not allowed to access data then the storage device 102 denies data access permission in step 210. In at least one example embodiment, the data access permission may be different for different functions of the host 101 for the same LBA range in the storage device 102. Moreover, the LBA range table may include data access permissions for a plurality of LBA ranges for one or more hosts, and for each of the hosts and/or LBA ranges, the data access permission may be different for different functions of the hosts and/or LBA ranges.

The various actions in method 200 may be performed in the order presented by one or more processors of a processing device, a computing device, a controller associated with a storage device, etc., in a different order or simultaneously. Further, in some example embodiments, some actions listed in FIG. 2 may be omitted, or additional actions may be included in the method.

FIG. 3 is an example diagram illustrating a LBA range table that includes the lock status for at least one LBA range according to at least one example embodiment. According to at least one example embodiment, each record of the LBA range table may include a field 301 indicating the start value of the LBA range and a field 302 indicating the end value of the LBA range. The LBA range record may also include an array including the write lock status for each PCIe function associated with one or more hosts associated with the storage device, and an array including the read lock status per function for each PCIe function associated with one or more hosts associated with the storage device. For example, the LBA range record may include a write lock status array 303 that stores the write lock status for PCIe functions [0 to N], where N is a natural number for host 1, and a read lock status array for PCIe functions [0 to N] 304 for host 1. While only a single record of the LBA range table is illustrated, the example embodiments are not limited thereto and the LBA range table may include a plurality of records. Further, each of the records may also include additional fields, or may omit illustrated fields.

The LBA range record may include write lock status arrays and read lock status arrays (and/or status arrays for other access permission settings, such as execute, manage, etc. not illustrated) for additional hosts as well, such as status arrays for host 1 to host M (e.g., status arrays 305 and 306), where M is a natural number. The values stored in the status arrays associated with and/or related to each PCIe function for each host may be used to determine the access permissions granted to the specified PCIe function. Additionally, in this example embodiment, a value ‘1’ stored in the status array may indicate that a permission is allowed, and a value ‘0’ may indicate that permission is denied, but the example embodiments are not limited thereto and other values may be used to express the permission values. For example, a specified PCIe function for host 1 may be determined to have READ/WRITE access if the read lock status array field and the write lock status array field for the specified PCIe function are set to a “1” value. The specified PCIe function may be determined to have ONLY READ access if only the read lock status array field for the specified PCIe function is set to a “1” value, while the write lock status array field is set to a “0” value. The specified PCIe function may be determined to have ONLY WRITE access if only the write lock status array field for the specified PCIe function is set to a “1” value, while the read lock status array field is set to a “0” value. Also, the specified PCIe function may be determined to have NO ACCESS if both the read lock status array field and the write lock status array field for the specified PCIe function are set to“0” values. However, the example embodiments are not limited thereto and there may be other access permissions available for the PCIe functions of the host devices.

Moreover, while an example embodiment of the LBA range table is illustrated in FIG. 3, the example embodiments are not limited thereto and the LBA range table may be arranged in other configurations.

The example embodiments disclosed herein may be implemented through at least one software program running on at least one hardware device and performing network management functions to control the network elements. The network elements shown in FIG. 1 include blocks which may be at least one of a hardware device, or a combination of a hardware device and a software module.

The example embodiments disclosed herein specify a mechanism for defining data access permissions at a function level. The mechanism allows different data access permissions for different PCIe functions of a host or multiple hosts, providing a system thereof. Therefore, it is understood that the scope of protection is extended to such a system and by extension, to non-transitory computer readable media having a computer readable instructions stored thereon for implementation of one or more steps of the method, when the program runs on a server, a mobile device, a personal computer, or any other suitable programmable processing device. The method is implemented in at least one example embodiment using the system together with a software program written in, for example, Very high speed integrated circuit Hardware Description Language (VHDL), another programming language, or implemented by one or more VHDL or several software modules being executed on at least one hardware device.

The units and/or modules described herein may be implemented using hardware components and/or a combination of hardware and software components. For example, the hardware components may include microcontrollers, memory modules, and processing devices, or the like. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

What is claimed is:

1. A method for customizing access permission to a storage device for at least one Peripheral Component Interconnect Express (PCIe) function of a host, the method comprising:
defining, using at least one processor, at least one Logical Block Addressing (LBA) range for data in the storage device;
defining, using the at least one processor, at least one lock status associated with the at least one PCIe function associated with the defined LBA range; and
determining, using the at least one processor, an access permission for the PCIe function of the host based on the defined lock status of the PCIe function.

2. The method as claimed in claim 1, wherein the determining the access permission for the PCIe function of the host further comprises:
receiving a data access request from the PCIe function of the host, using the storage device, the data access request including a request LBA range;
checking the lock status corresponding to the requested LBA range for the PCIe function, using the storage device;
allowing the PCIe function to access the LBA range if the lock status permits the data access, using the storage device; and
preventing the PCIe function from accessing the LBA range if the lock status does not permit the data access, using the storage device.

3. The method as claimed in claim 1, wherein the access permission is at least one of a READ/WRITE, ONLY READ, ONLY WRITE, and NO ACCESS.

4. The method as claimed in claim 1, wherein the lock status is stored in at least one Special Function Register (SFR) of the storage device.

5. A storage device for customizing access permission for at least one Peripheral Component Interconnect Express (PCIe) function of a host to data stored in the storage device, the storage device comprising:
a hardware processor;
a non-volatile memory comprising computer readable instructions, which when executed by the hardware processor, cause the hardware processor to,
define at least one Logical Block Addressing (LBA) range for data in the storage device;
define at least one lock status associated with the at least one PCIe function associated with the defined LBA range; and
determine an access permission for the PCIe function of the host based on the defined lock status of the PCIe function.

6. The storage device as claimed in claim 5, wherein the hardware processor is further caused to determine the access permission for the function of the host by:
receiving a data access request from the PCIe function of the host, the data access request including a request LBA range;
checking the lock status corresponding the requested LBA range for the PCIe function;
allowing the PCIe function to access the LBA range if the lock status permits the data access; and
preventing the PCIe function from accessing the LBA range if the lock status does not permit the data access.

7. The storage device as claimed in claim 5, wherein the hardware processor is further caused to set at least one of a READ/WRITE, ONLY READ, ONLY WRITE, and NO ACCESS, as the access permission.

8. The storage device as claimed in claim 5, wherein the hardware processor is further caused to store the lock status in at least one Special Function Register (SFR).

9. A method for managing a Logical Block Addressing (LBA) range comprising: receiving, using at least one processor, at least one data access request from at least one Peripheral Component Interconnect Express (PCIe) function associated with a host, the data access request including a desired LBA range and a desired access type;
verifying, using the at least one processor, the data access request based on a LBA range table record of a LBA range table associated with the desired LBA range, the PCIe function, and the host; and
permitting, using the at least one processor, the data access request based on results of the verifying.

10. The method as claimed in clam 9, wherein the verifying further includes:
determining, using the at least one processor, whether the LBA range table record includes at least one lock status array associated with the PCIe function and the host; retrieving, using the at least one processor, the lock status array values associated with the PCIe function and the host based on results of the determining; and
determining, using the at least one processor, an access permission status for the PCIe function based on results of the retrieving.

11. The method as claimed in claim 9, wherein the LBA range table includes a plurality of LBA range records, each of the LBA range records associated with a desired LBA range.

12. The method as claimed in claim 9, wherein
the at least one data access request is a plurality of data access requests; and
the plurality of data access requests are transmitted by a plurality of hosts.

13. The method as claimed in claim 11, wherein the plurality of LBA range records each include at least one lock status array associated with a plurality of PCIe functions associated with the host.
